(19) United States
(12) Patent Application Publication
(10) Pub. No.: US 2015/0120498 A1
(43) Pub. Date: Apr. 30, 2015

(54) METHOD FOR ASSISTING IN LOCATING A DESIRED ITEM IN A STORAGE LOCATION

(71) Applicants: Joshua Carney, Goteborg (SE); Henrik Carlén, Vastra Frolunda (SE); Kent Hermansson, Goteborg (SE)

(72) Inventors: Joshua Carney, Goteborg (SE); Henrik Carlén, Vastra Frolunda (SE); Kent Hermansson, Goteborg (SE)

(73) Assignee: SCA Hygience Products AB, Göteborg (SE)

(21) Appl. No.: 14/399,633

(22) PCT Filed: May 10, 2012
(86) PCT No.: PCT/SE2012/050495

§ 371 Date: Dec. 5, 2014

(51) Int. Cl. G06Q 30/06; G06K 9/00

(52) U.S. Cl. CPC G06Q 30/0639; G06K 9/00624
USPC 705/26.9

(57) ABSTRACT

A method for assisting in locating the occurrence of at least one desired item in a storage location includes steps performed by a mobile device that has an image capturing device. The steps include capturing at least one image or video sequence or live video feed representing said storage location via the image capturing device; recognizing any occurrence of the desired item within the captured image or video sequence or live video feed; presenting information related to the location of the desired item; and, in the event that the desired item is not captured by the image capturing device, providing a notification of at least one alternative item.

### TECHNICAL FIELD

The present disclosure relates to a method for assisting in locating the occurrence of at least one desired item in a storage location.

### BACKGROUND ART

Today, is it common that shops such as retail markets, supermarkets and other stores sell a large variety of products and goods which are arranged and put on display on shelves forming aisles in said shops.

Large supermarkets, in particular, may offer a very large number of different products from different suppliers. For this reason, it can sometimes be very difficult for the consumer to locate a certain desired product in such a vast selection of products on display.

In particular, in some areas and for certain types of goods, it can also be difficult for a consumer in a supermarket, for example, to actually distinguish between different, but similar, products within a particular product category.

One particular field of products in which it can be particularly difficult for a consumer to actually locate a particular desired product is the field of hygiene products, especially in the form of absorbent articles. Such articles are marketed in the form of feminine hygiene products such as sanitary napkins, or alternatively baby products such as diapers, or alternatively incontinence products for both women and men. All these types of products can, at first sight, be quite similar in the way they are packaged, marketed and sold. The product names of absorbent hygiene products can also be difficult to distinguish from one another. Also, all these types of products may be positioned in generally the same area of a supermarket, for example.

In summary, a consumer of an absorbent product may be faced with a vast range of manufacturers and types of products. All these products may come in similarly designed packages and with similar product names, which can be confusing for the consumer.

Consequently, the assortment of products within this field may appear to be complicated and difficult to comprehend for the customer. Also, absorbent hygiene products may sometimes also suffer from “poor shelf placement”, which means that they may be placed on shelves (in a shop or supermarket) which are not easy to find, or that they may be placed in position in which they will not get the customer's immediate attention.

In summary, it is understood that it is difficult for the consumer to understand and grasp the whole range of hygiene products being on the market today. Sometimes, a consumer who comes into a supermarket may know exactly which product to choose, but often the customer needs assistance for choosing a suitable product.

It is previously known to use modern computer-based systems for assisting a user, for example a customer in a supermarket, in finding a particular product. The patent document US 2010/0013662, for example, relates to a product locating system using RFID devices which are positioned on a particular product or on a shelf on which the product is positioned. The customer can enter information regarding a product description on a fixed computer terminal in the supermarket and the RFID device will subsequently return a signal to the computer terminal which indicates the position of the product in question.

Furthermore, the patent document US 2012/0023034 discloses a system for locating merchandise in a store, wherein the products in the store are provided with location indicators. The customers in the store may find the products by accessing a database in which information regarding the location of the products are stored.

Although the above-mentioned systems and methods are related to aiding a user such as a customer in a store in finding desired products, they are unnecessarily complex and can be perceived as difficult to use for the customer. Consequently, there is a need for improved systems and methods which are easy to use and which give clear and useful information for assisting a customer in locating items such as products in a supermarket or similar storage location. In particular, there is a need for today's customers to find guidance regarding suitable products within a particular product type or from a particular producer,

### SUMMARY

Consequently, it is an object of the present disclosure to solve the above-mentioned problem and to provide a method which can be used to assist for example the user of a particular desired product, for example an absorbent product, in order to locate that particular product in a storage location, for example a supermarket, a warehouse or similar, and also to be supplied with suitable information regarding other products which can be available of a particular type or from a certain producer. More precisely, it is an object of the present disclosure to provide a method by means of which a consumer can be assisted in finding suitable alternatives to a particular desired product or product type in case such product or product type is not available in the location in question.

In particular, it is an object of the present disclosure to provide a method and device which are easy to use and which can give a user clear information on a mobile device regarding the desired product, and suitable alternative products, in said storage location.

Yet another object of the present disclosure is to provide a method that facilitates, for users of a product, such as an absorbent hygiene product, to retrieve product-related information in addition to finding the location of said product.

These and other objects are achieved by a method for assisting in locating the occurrence of at least one desired item in a storage location, comprising at least the following steps, performed by a mobile device comprising an image capturing device: capturing at least one image or video sequence or live video feed representing said storage location by means of said image capturing device, recognizing any occurrence of said desired item within said captured image or video sequence or live video feed; presenting information related to the location of said desired item; and, in the event that said desired item is not captured by said image capturing device, providing a notification of at least one alternative item.

The present disclosure offers an advantage in that a customer may obtain information regarding which products are suitable and available alternatives in case an originally desired product is out of stock or if it is not available or if it cannot be found by the customer.

The present disclosure relies on the insight that a mobile device, provided with an image capturing device such as a conventional camera provided on a mobile device (for example a mobile telephone) could be used to scan at least a certain section of the storage space in order to capture an image or a video sequence of a storage location in which it is believed that the desired product is located.

Furthermore, the mobile device contains suitable software for recognizing whether the desired product is located within the field of scan of the camera. This can be obtained through the use of image analysis of the captured image or video sequence, wherein the graphical representation of the product can be detected and identified by the software. If the product is identified, the software will preferably indicate this immediately to the user of the mobile device, by including suitable information on the display of the mobile device.

If the desired product is not detected and identified, the software in the mobile device will be arranged so as to indicate to the user of the mobile device a certain number of alternative products, i.e. relevant alternatives to the originally desired product. The alternative product or products can be indicated based on certain criteria; for example, the alternatives presented can be a product of the same product type but from another manufacturer (which can be the case in the field of hygiene products such as for example diapers or sanitary napkins), or can be a product from the same manufacturer as the originally desired product but with different properties, or can be a product from a similar price range as the originally desired product. Also, a product can be presented as an alternative based on the fact that its usage, size, colour, features or similar criteria are generally similar to the desired product.

The notification of the existence of an alternative product can be followed by an indication of the actual location of the alternative product within the storage location, that is, if the product is actually in stock and exists within the storage location.

It should be noted that the captured image or images as mentioned above could be in the form of one or more single images, a recorded video sequence or a live video feed, i.e. a live streaming video sequence.

Due to the fact that a mobile device can be used to present information related to said product and certain alternative products, the user may obtain such information—i.e. in addition to information allowing the user to find the actual location of the product—in order to select a suitable product. Such information can reflect for example the properties, price or quality of the product. Such product-related information can be provided by visual, aural, tactile or otherwise physical means, or any combination of such means, on the mobile device, and/or a communication device to which the mobile device is communicatively connectable, e.g. another mobile device.

The use of a mobile device comprising an image capturing device, such as a mobile phone, a so-called smartphone, a personal digital assistant (PDA), a tablet computer or the like, or a wearable device such as a pair of glasses, makes the method readily available to anyone in possession of such a mobile device.

The method is performed by the mobile device through execution of a computer program, which, in a preferred embodiment, is realised in form of an application program (hereinafter referred to as an “App”, or “application”, which consequently is used here to describe a piece of software designed to help a user of a mobile device to carry out specific tasks). The App is suitably arranged to be downloadable to a storage medium of the mobile device.

By allowing the method to be performed through the execution of an App that may be downloaded into existing mobile devices, the method becomes readily available to any user.

In order to perform the method, the mobile device is suitably positioned by a user in a position where it can be used for scanning at least a section of a storage space in which the desired product can be expected to be located. Preferably, the image capturing device is a camera which is sensitive enough to register images of relatively high resolution.

The results of the image capturing step may be more reliable if a high-resolution camera is used and also if the mobile device is held steadily at a suitable distance to the used absorbent product.

In summary, this means that a clear indication regarding the location, and optionally also the properties, of a desired product can be provided to the user via the mobile device's graphical user interface during the actual scanning of the storage space, and, in case such a desired product is not found, certain alternative products will be proposed to the user. Optionally, the location of such alternative products can also be indicated to the user, in the event that such alternative are available in the storage location.

Furthermore, the present disclosure suitably makes use of a light source which for this purpose is integrated within the mobile device. Such is the case of conventional mobile telephones, which use a light source used for photographing where natural light conditions are insufficient. Consequently, the present disclosure suitably comprises a step of illuminating the storage location with an integrated light source of the mobile device during the image capturing stage. Alternatively, the present disclosure could be used for capturing images with the aid of a separate light source, i.e. it does not have to be an integrated part of the mobile device.

The image capturing can be carried out in at least two ways; the image capturing device can be used either for capturing one single image of the product; or the image capturing device can be used for obtaining a video, or multiple-image, sequence of images while scanning, or swiping, the mobile device along the storage location. Both these types of methods enable the user to input image information into the software of the mobile device in order to allow a processor of the mobile device to determine where the product in question is located.

As indicated above, the method may be a computer-implemented method performed by a mobile device through execution of a computer program. Thus, according to another aspect of the present disclosure there is provided a computer program for assisting in locating at least one item in a storage location. When executed by a microprocessor, the computer program is configured to perform a method as described above. The present disclosure also provides a computer program product comprising a non-volatile memory for storing computer-readable instructions, wherein the above mentioned computer program is encoded on said non-volatile memory.

Furthermore, the present disclosure relates to a mobile device for assisting a user in locating a particular desired product in a storage location, which mobile device comprises an image capturing device, a processor and a storage medium for storing computer programs executable by said processor. Also, the storage medium stores the above mentioned computer program. Additionally, the mobile device according to the present disclosure is arranged for providing information regarding at least one alternative product in case the originally desired product cannot be found.

The desired product in question, for example an item which a user of the present disclosure can be expected to search for in the storage location (for example a supermarket) is suitably included in a database which also includes data related to one or more products which can be regarded as alternative products to the desired product. In this manner, at least one of the alternative products can be proposed to a user of the mobile device in the event that the desired product cannot be found.

It should be noted that the present disclosure is for example suitable to be used in connection with products in the form of hygiene products such as absorbent products as mentioned above. Such absorbent products can be any form of absorbent personal hygiene article, such as a male or female incontinence protector, a sanitary pad, a panty liner or a diaper, for example a diaper with tape fastener, a pant diaper or a belted diaper. Said hygiene products can also be constituted by lotions, wipes or towels, for example paper towels for hygiene use.

### BRIEF DESCRIPTION OF DRAWINGS

Embodiments will be described below with reference to the appended drawings, in which:

FIG. 1 illustrates a storage location which is of the type which can be found in a supermarket or a similar environment, wherein a user is located;

FIG. 2 illustrates a mobile device and the storage location regarded from another angle as compared with FIG. 1 and showing the method according to the present disclosure;

FIGS. 3a, 3b and 3c show a mobile device in use for finding a desired product; and

FIGS. 4a and 4b show a mobile device being used in accordance with the principles of the present disclosure.

### DETAILED DESCRIPTION OF EMBODIMENTS

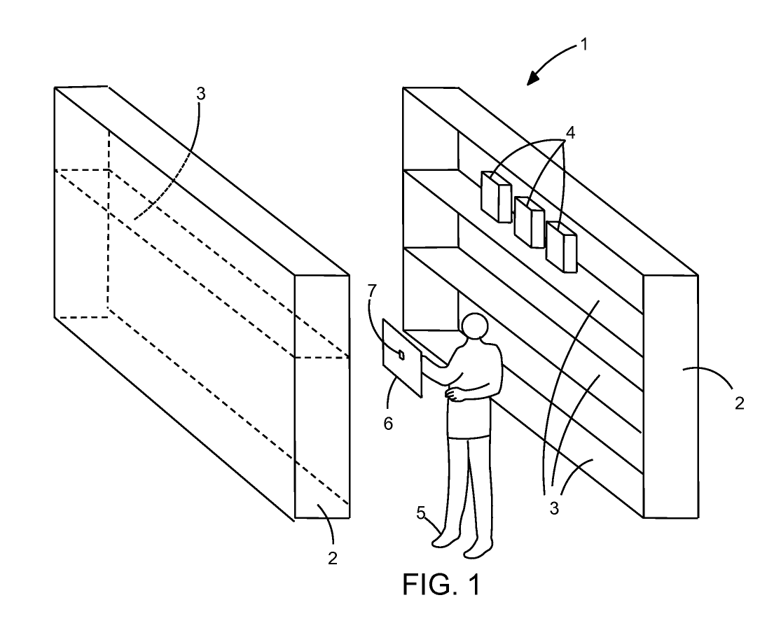

FIG. 1 illustrates a storage location 1 for a number of different products, such as a space which is to be found in a supermarket, a warehouse, a shop, a library or a similar type of environment. The storage location 1 comprises a number of storage devices 2 which according to the embodiment is based on a number of shelves 3 on which a number of items in the form of marketed products 4 are located.

Also, FIG. 1 shows a user 5, i.e. a person who is equipped with a mobile device 6. As will be explained in detail below, the mobile device 6 is arranged so as to be able to execute the present disclosure. The mobile device 6 shown in FIG. 1 is in the form of a so-called tablet computer, but it should be appreciated that any type of mobile device, such as a mobile phone, a personal digital assistant (PDA), a so-called smartphone or similar may be used to perform the method of the present disclosure. The mobile device 6 can alternatively also be in the form of a wearable article such as a pair of glasses.

The mobile device 6 comprises an integrated image capturing device 7 for capturing images and video recordings, to be subsequently stored in the mobile device 6. It should be noted here that the present disclosure is not limited to a method in which the information regarding said images and video recordings are stored in the mobile device 6 only, but can also be implemented in a manner in which the captured images and video sequences are transmitted to a remote computer (not shown in the drawings) for further analysis remote from the mobile device 6 and the user 5.

An image capturing devices 7 as mentioned above is generally known and typically comprises an image sensor and a lens (not shown) which are used for example in mobile telephones and tablet computers for capturing photographic images and video sequences.

Although not shown in detail in the drawings, the mobile device 6 comprises a processor for processing data. The data may be received from communication devices to which the mobile device 6 is communicatively connectable via a network, or stored on a digital storage medium of the mobile device, which storage medium is accessible by said processor.

Consequently, the mobile device 6 carries a computer program which is stored in the storage medium and, when executed by the processor, causes the mobile device 6 to perform the method according to the present disclosure, as will be described below.

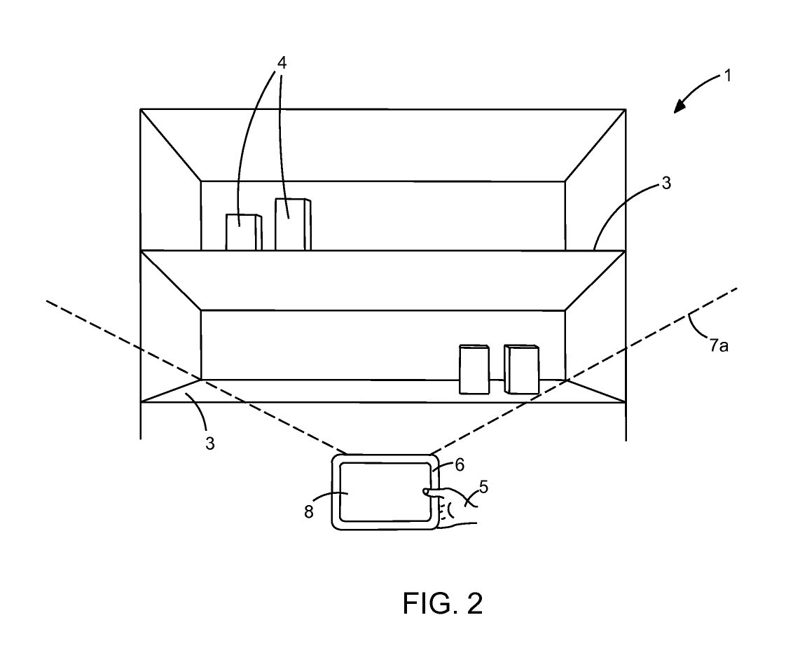

FIG. 2 shows a mobile device 6 as regarded from a different angle, i.e. an angle as seen from the perspective of the user 5 when facing a set of shelves 3 in the storage location 1. As indicated in FIG. 2, the mobile device 6 according to the embodiment comprises a display 8 for displaying information to the user 5, and, if realised in form of a so-called touch display, also for receiving information from the user 5 in the form of user input. The mobile device 6 may also comprise other means for receiving user input, such as buttons, microphones, as well as means for outputting signals and information, such as for example a loudspeaker, a vibratory device etc. Such additional devices are generally known and for this reason they are not explained in detail here.

Consequently, according to the embodiment, the display 8 constitutes a user interface for inputting information and instructions from the user 5. As will be explained below, the display 8 preferably also constitutes a means for displaying visual information relating to the location of a desired product or other relevant information regarding the product, such as its price, properties or size.

The mobile device 6 is operable to perform all method steps of the inventive method, which method steps will be described in more detail below, through execution of a computer program stored in the storage medium.

Preferably, the computer program is realised in form of a stand-alone application, meaning that no data has to be received from external devices in order to run the program. However, the computer program may also be a client application of a distributed software solution further comprising a server-side application residing in an application server to which the mobile device is communicatively connectable. In this case, some of the method steps described below may be performed by the application server through execution of the server-side application.

In a preferred embodiment, the computer program stored on the mobile device 6 is realised in form of an App (or “application program”) which is downloadable into the storage medium from a downloading server to which the mobile device 6 is connectable. The App is preferably adapted to the Apple iOS platform and/or the Android platform and distributed through known distribution channels.

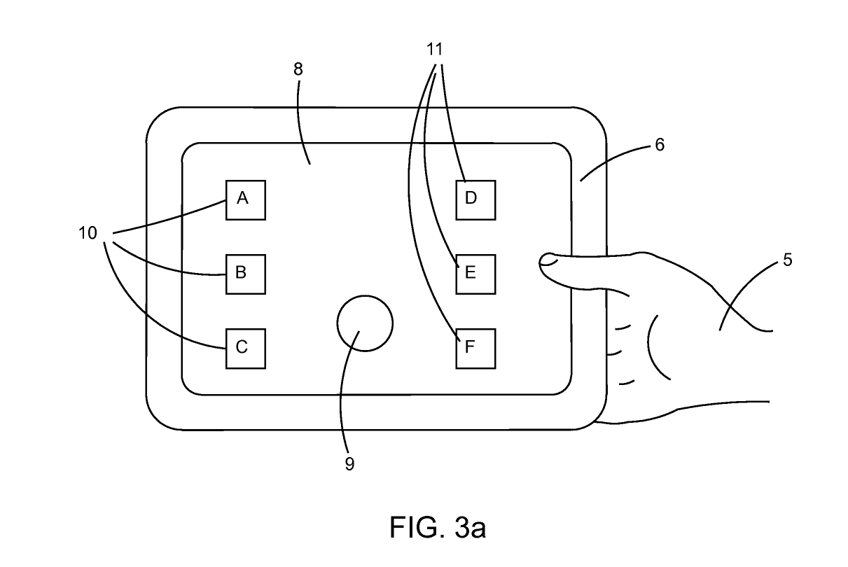

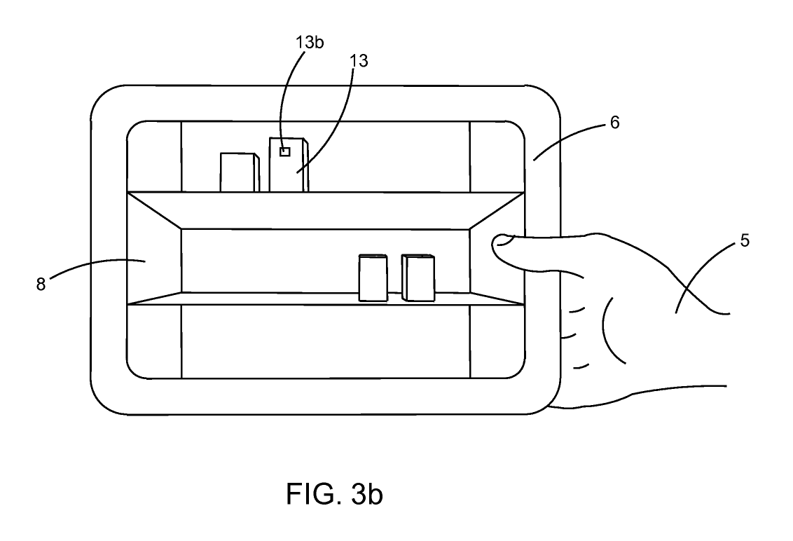

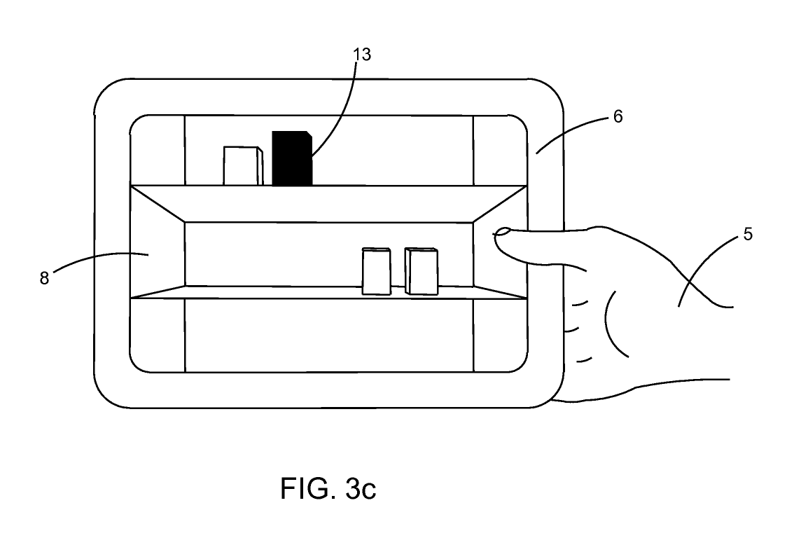

It should thus be appreciated that the “App” hereinafter refers to a computer program stored on the storage medium of the mobile device 6. As indicated in a simplified form in FIG. 3a, the App can be executed by means of a suitable user input, for example in the form of a particular icon 9 on the display 8 which the user touches and which in this embodiment corresponds to a “start button” for the App.

Furthermore, in accordance with an embodiment, the App comprises displaying a number of further user input icons such a first series of icons in the form of product icons 10 which are used in order for the user 5 to select which product the user 5 wishes to find in the storage location 1. i.e. a selection between products, or items, A, B or C.

The icons 10 representing items A, B and C can for example be said to represent a particular product category, for example incontinence pads. The mobile device 6 can furthermore be arranged for allowing the user 5 to select an item from a further product category, for example baby diapers, For this reason, the App according to the present disclosure can be arranged to present a second series of icons 11 on the display 8 corresponding to said further product category. As indicated in FIG. 3a, the user 5 may then select between different items representing different product types.

In accordance with the embodiment, the App in the mobile device 6 is initiated when the user 9 touches the “start” icon 9 shown in FIG. 3a. When this occurs, the App will enter a mode in which the image capturing device (not visible from the view in FIG. 3a) starts capturing a series of images, suitably in the form of a video sequence, displaying at least a part of the storage space 1. With reference to FIG. 3b, the display 8 of the mobile device 6 is then showing a corresponding picture, suitably in the form of a live feed of said video sequence, of the storage location 1.

Preferably, the image capturing device 7 s in the form of a camera and is positioned on the rear side of the mobile device 6. However, the embodiment is not limited to such placement only, i.e. the image capturing device 7 could for example be placed on the top surface or along the side edge of the mobile device 1.

As indicated in a simplified manner in FIG. 2, the image capturing device is arranged for capturing the pictures or video sequence within a particular image capturing angle 7a.

At this stage, the user 5 may use the mobile device 6 to sweep along the storage location 1 as if to “search for” a particular desired product. In other words, the user 5 will direct the mobile device 6 towards a position on a shelf 3 or in a section of the storage location 1 where the particular desired product can be expected to be found. In FIG. 3b, such a desired product is indicated by means of reference numeral 13. Furthermore, this product 13 is provided with a particular recognition graphic 13b which can be recognized by means of image processing software in the mobile device 6.

In accordance with the embodiment, and in order to recognize the desired product, the mobile device 6 is arranged for capturing and analyzing the pictures or video sequences through image recognition, according to principles which are well known to the skilled person and which for this reason are not described in detail here.

In accordance with the embodiment, the mobile device 6 is particularly adapted for recognizing a graphic representation of the desired product 13. Such recognition can be based on an image analysis of the design of the product packaging, wholly or in part, with regard to its shape, design, colour, pattern or particular features printed or otherwise applied to the product packaging. The mobile device 6 can be adapted to recognize the entire product 13 or a part thereof.

Consequently, a particular part, shape, marking or design of the product 13—which can be referred to as a recognition graphic—can be detected, analyzed and recognized by means of the mobile device 6. This recognition graphic is indicated schematically in FIG. 3b by means of reference numeral 13b.

The App according to the present disclosure is consequently arranged for image recognition of such type that the recognition graphic 13b of the product 13 is recognized and when this occurs, an image or suitable graphical representation of the product 13 is shown on the display 8 in a manner so that the user can easily distinguish it from the other products shown on the display 8. For example, the software in the mobile device 6 can be arranged so that the desired product 13 is shown having its outline or contour of the product 13 shown in a suitable colour, for example red. In this manner, the product 13 in question can be easily detected on the display 8. This is shown in FIG. 3c. The graphical representation of the product 13 is suitably shown superimposed onto the displayed image or video sequence on said display 8, in a position corresponding to the photographic image or video sequence of the product 13.

It should be noted that information regarding the exact position of the product 13 is not required, just information regarding the location of the product 13 in relation to the mobile device 6.

The information relating to the location of the product 13 can also be in the form of aural information such as for example sound effects or spoken messages or in the form of tactile or some other type of information indicated by physical means such as vibrations, or a combination of visual, aural, tactile or other physical information.

The present disclosure is not limited to the above-mentioned image recognition only, but can be realized in alternative ways, for example through the use of NFC (Near Field Recognition) tags, transponders, QR codes or other devices or markings which allow the mobile device 6 with its image capturing device 7 to determine the location of the product 13 in question and to present information related to said location to a user 5.

Furthermore, the present disclosure can optionally be arranged so that product-related information regarding the product 13 in question is also presented to the user 5. In such case, said product-related information can be constituted by information related to the price, contents, properties or handling of the product 13.

The information presented to the user 5 can also be constituted by information not relating to the actual product 13 but to some other related factors, such as information regarding ongoing sales or information regarding similar products.

Furthermore, the present disclosure can optionally be arranged so that the user 5 makes a selection of one or more desired products after the actual image scanning and image recognition has been concluded. For example, the user 5 may instruct the mobile device to start scanning a particular storage location 1 where it can be expected that a number of products, which may or may not be of interest to the user 5, are located. If and when the mobile device 6 recognizes the occurrence of one or more desired products, information relating to these products are shown on the display 8.

The description of the embodiment above relates to a situation in which a user searches for, and finds, a particular desired product 13. At this stage, it should be noted that the present disclosure is particularly directed to a method and device which can be used where the user does not find the desired product, and wherein said mobile device 6 can be used for proposing one or more alternative products.

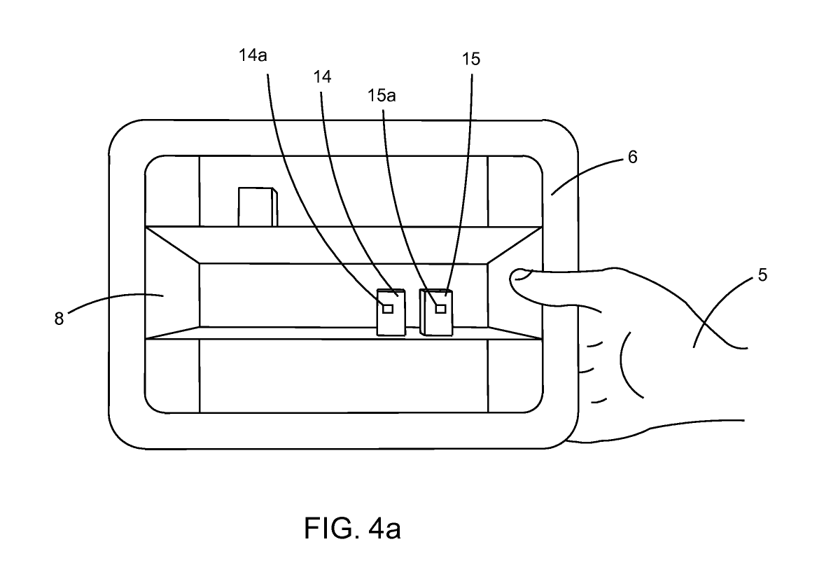

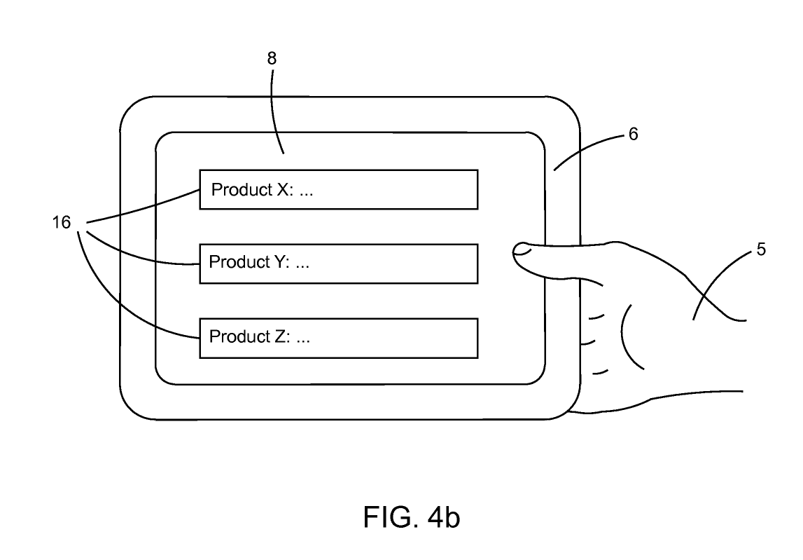

More precisely, the intention with FIG. 4a is to indicate such a situation in which the desired product—which is indicated by means of reference numeral 13 in FIGS. 3b and 3c—is lacking from FIG. 4a. Instead, certain alternative products 14, 15 are assumed to be present in the same storage location, in the vicinity of the originally desired products. In accordance with the description above, such alternative products 14, 15 could be recognized by means of image recognition based on the detection and recognition of a recognition graphic 14a, 15a on each alternative product 14, 15. This is carried out in generally the same manner as has been described above with reference to FIGS. 3a-3c.

The alternative products 14, 15 can be determined to be “alternatives” to the originally desired product based on one or more criteria. For example, they could be selected as alternatives based on the fact that they belong to the same type of products, that they are priced in generally the same price range as the originally desired product or that they originate from the same producer as the originally desired product. Other criteria are also possible within the scope of the present disclosure.

Furthermore, there is suitably provided a database (not shown in the drawings) which contains data related to the desired product, i.e. an item which a user of the present disclosure can be expected to search for in the storage location. Such a database can be maintained at a central location by a company being responsible for the storage location. Said database preferably also contains data related to other products which—based on one or more suitable criteria—can be regarded as alternative products, i.e. alternatives to the desired product. If the mobile device 6 is used to find a desired product, as described above, but does not find it, said mobile device 6 is suitably connected to said database in order to retrieve information related to one or more alternative products.

A database of the above-mentioned type is arranged to be updated at a regular interval with information related to products which in this context are desired products or alternative products, for example as regards the price, features or design of the products. In this manner, the mobile device has access to relevant, updated information which forms the basis of the selection of alternative products according to the above-mentioned description.

If the alternative products 14, 15 are positioned within the field of view of the mobile device 6, they are indicated in some particular manner so that the user can easily distinguish them from other products shown on the display 8. For example, the software in the mobile device 6 can be arranged so that the alternative products 14, 15 are shown having their outline or contour shown in a suitable colour, for example green. (This is not shown in FIG. 4a.) In this manner, the alternative products 14, 15 can be easily detected on the display 8. The graphical representation of the alternative products 14, 15 is suitably shown superimposed onto the displayed image or video sequence on said display 8, in a position corresponding to the photographic image or video sequence of the alternative products 14, 15.

The description with reference to FIG. 4a refers to a situation in which the alternative products 14, 15 are actually located in the storage location and can be recognized by the mobile device 6. The present disclosure can also be used in a situation in which the software in the mobile device 6 proposes certain alternative product which however are not available in the storage location in question. Such a situation is shown in FIG. 4b.

As indicated in FIG. 4b, the mobile device 6 is arranged for showing certain data or information regarding alternative products which are available to the user but which are not available for the moment in the storage location, or which are not positioned within the field of view of the image capturing device of the mobile device 6. According to the embodiment illustrated in FIG. 4b, the display 8 shows product information related to three different alternative products X, Y and Z. Such product information can contain information regarding price, product type, manufacturer or some other type of information which is relevant to the user.

This means that the present disclosure can be used in situation when the location of the alternative products is indicated and also in a situation in which the alternative products are described even though they are not available for the moment in the storage location in question.

As mentioned above, the alternative products 14, 15 can be determined to be “alternatives” to an originally desired product 13 based on certain predetermined criteria. In accordance with an embodiment, the user may select which criteria are to be used in order to determine which product or products are to be termed as “alternative products”. For example, the user may input information (suitably by tapping on a corresponding icon on the display 8; not shown in the drawings) instructing the mobile device 6 to use “product price” as a decisive criterion. This means that, in case the originally desired product is not found, the mobile device will present one or more alternative products (of the same product type) which are in generally the same price range as the originally desired product. According to another example, the user may select “manufacturer” as the decisive criterion. This means that, in case the originally desired product is not found, the mobile device will present one or more alternative products (of the same product type) which are from the same manufacturer as the originally desired product. Generally, it can be noted that the user may select one or several criteria which are decisive for determining which products are to be selected as being “alternatives”.

Furthermore, the mobile device 6 can be provided with a set of information in the form of a “shopping list”, i.e. a number of desired products which the user 5 wishes to purchase. When the user 5 uses the mobile device 6 to scan the storage location 1 in the supermarket, the mobile device will 6 recognize and show on the display 8 any item from such a shopping list. In this case, the mobile device 6 is arranged for finding more than one product simultaneously. In case any one of the desired products are not recognized by the mobile device, the software may propose alternative products in a manner which corresponds to the description above with reference to FIG. 4a.

Furthermore, the mobile device 1 preferably comprises a light source (not shown in the drawings) which can be a conventional flash-type light device as used in many of today's mobile devices such as mobile telephones. The light source is arranged for generating a field of light (not shown in the drawings) directed from the mobile device 6. Alternatively, the present disclosure could be used with a separate light source or with natural ambient light only, if the light conditions are sufficient.

Furthermore, and although not shown in the drawings, it should be noted that the mobile device could be in the form of an autonomous vehicle or similar carrier of an image capturing device. Such an autonomous carrier could be programmed to follow a path within a storage location while capturing images (i.e. one or more single images, a video sequence or a live video feed). These images could then be used in accordance with the principles of this present disclosure in order to assist in locating an item within said storage location.

The present disclosure is particularly suitable for absorbent products but is not limited to such products only, but can be used generally for all sorts of merchandise and goods as long as they are positioned in the storage space 1 and can be captured by the image capturing device 7.

In case that the product is a hygiene product, the present disclosure can be used with all types of hygiene products such as absorbent products in the form of male or female incontinence pad, a sanitary pad or a diaper, for example a diaper with tape fastener, a pant diaper or a belted diaper. The present disclosure can also be used with other types of hygiene products such as lotion, wipes or towels.

As an optional additional step, the mobile device 6 can suitably be arranged to provide item-related, or product-related, information regarding the product 13 and to show such information on the display 8. Examples of such product-related information is the size, price or contents of the product 13, or for example a manual of operation for the product 13.

Obviously, the processor may be adapted for displaying a variety of information on the display 8. For the normal user it can be assumed that the most helpful information to be displayed is information directly related to suggestions on how to use the product 13. In this manner, the present disclosure can be used in a highly user-friendly manner.

As mentioned above, the present disclosure can be arranged so that one or more alternative products are presented to the user via the display 8. For example, in the event that the originally desired product is not found, the processor may be arranged to present a list of alternative products on the display 8. The user may then select a first product in the list in order to receive information regarding the location and other properties of the product. If the user is not interested in buying that particular proposed product, the user may provide user input (for example, by tapping on an icon on the display) in order for the mobile device to present information regarding the second alternative product, and then the third alternative product etc., in the list of alternative products.

The present disclosure is not limited to the embodiments described above, but can be varied within the scope of the subsequent claims.

For example, the mobile device 6 may use an built-in accelerometer, gyro or gyroscope device (not shown) in order to sense the acceleration or orientation of the mobile device 6. Such a device can be used for inputting commands from the user 5. For example, the user 5 can then initiate a search for a desired product 13 (instead of tapping on the “start” icon 9 mentioned above) by shaking the mobile device 6. An accelerometer or gyroscope is then used to detect this shaking movement in order to trigger the start of the image capturing process according to the embodiment.

Furthermore, as mentioned above, the mobile device is suitably in the form of a tablet computer, a mobile phone or the like, but could alternatively be constituted by an autonomous mobile device carrying an image capturing device and being arranged for scanning the storage location in order to locate one or more desired items in said storage location.

Furthermore, it is not necessary to analyze the contents of the captured image or video sequence at the same time that the image or video sequence is actually shown on the display. For example, the captured images can be transferred to a remote computer and be analyzed at a suitable point in time.

Also, the software in the mobile device is suitably regularly updated, for example through contact with a central server, with information related to suitable alternatives to certain products.

1. A method for assisting in locating the occurrence of at least one desired item in a storage location, comprising at least the following steps performed by a mobile device comprising an image capturing device:
capturing at least one image, video sequence or live video feed representing said storage location by means of said image capturing device,
recognizing any occurrence of said desired item within said captured image, video sequence or live video feed, via an image processing software recognizing a recognition graphic of said desired item, said recognition graphic being one of a particular part, shape, marking and design of said desired item;
when any occurrence of said desired item is recognized, presenting information related to a location of said desired item to a user of said mobile device on a display forming part of said mobile device; and
when said desired item is not captured by said image capturing device, accessing a database for selecting at least one alternative item and providing a notification with a presentation of said at least one alternative item on the display of said mobile device.

2. A method according to claim 1, wherein the step of providing a notification of said alternative item is associated with information relating to a location of said alternative item in said storage location.

3. A method according to claim 1, wherein said at least one alternative item is selected depending on at least one of price, manufacturer, product type, usage, size, colour and features.

4. A method according to claim 3, wherein the step of providing a notification of said alternative item is based on user input regarding one or more criteria which are decisive for determining which products are to be selected as being alternative items.

5. (canceled)

6. A method according to claim 1, comprising displaying said image, video sequence or live video feed on said display; and superimposing a graphical representation of said information related to the location of said desired item and said at least one alternative item onto the displayed image, video sequence on said display.

7. A method according to claim 1, comprising presenting item-related information regarding said desired item and said at least one alternative item on said display.

8. A method according to claim 7, wherein said item-related information is constituted by information related to at least one of price, contents, properties and handling of said desired item.

9. A method according to claim 1, wherein said step of providing a notification of at least one alternative item comprises presenting a list of alternative items and allowing the user to select between the alternative items in the list.

10. A method according to claim 1, comprising receiving input information from said user corresponding to selecting said desired item.

11. A method according to claim 10, comprising a step of selecting said desired item after said image, video sequence or live video feed is analysed.

12. (canceled)

13. A method according to claim 1, comprising the step of illuminating at least a part of the storage location in which the desired item is expected to be located with a light source.

14. A method according to claim 1, wherein said step of recognizing any occurrence of said desired item is combined with an output signal that is at least one of aural, tactile and vibratory.

15. A method according to claim 1, wherein the desired item is a hygiene article that is one of a male or female incontinence protector, a sanitary pad, a diaper with tape fastener, a pant diaper or a belted diaper; a lotion, a wipe and a towel.

16. A non-transitory computer-readable recording medium storing a computer program that is executable on a mobile device, the program issuing instructions for assisting in locating at least one desired item in a storage location, the program, when executed by a processor of the mobile device comprising an image capturing device, causes the mobile device to perform the method according to claim 1.

17. A mobile device for assisting in locating at least one desired item in a storage location, the mobile device comprising an image capturing device, a processor, and a storage medium for storing computer programs executable by said processor, wherein the storage medium stores a computer program according to claim 16.

18. A mobile device according to claim 17, being one of a tablet computer, a mobile phone, a personal digital assistant, a smartphone and a wearable mobile device.
